(19) United States
(12) Patent Application Publication
(10) Pub. No.: US 2008/0113707 A1
(43) Pub. Date: May 15, 2008

(54) Button panel with printed circuit board

(75) Inventors: Fred Nesemeier, Reno, NV (US); John Leagh Beadell, Sparks, NV (US); Russell Chudd, Reno, NV (US); Joseph Randy Hedrick, Reno, NV (US); Andrew Zoolakis, Carlsbad, CA (US); Charles Curbbun, Encinitas, CA (US); Kevin Simmons, San Diego, CA (US)

Correspondence Address: BEYER WEAVER LLP, P.O. BOX 70250, OAKLAND, CA, 94612-0250, US

(73) Assignee: IGT, Reno, NV (US)

(21) Appl. No.: 11/595,555

(22) Filed: Nov. 10, 2006

(51) Int. Cl. G06F 17/00

(52) U.S. Cl. 463/16; 463/47

(57) ABSTRACT

A button panel assembly for a gaming machine having a printed circuit board comprising a plurality of areas, each of the areas comprising traces for producing user input commands for a wagering game, and a waterproof layer comprising a plurality of buttons, each button corresponding to at least one of the plurality of areas and configured for accepting user input for the wagering game, and at least one of the plurality of buttons being further configured to simulate a resistive force of a conventional mechanical button used for accepting user input for the wagering game.

### FIELD OF THE INVENTION

The present invention relates to a button panel assembly for a gaming machine. More specifically, the present invention relates to a button panel assembly for a gaming machine having a waterproof layer and features to illuminate the button panel assembly.

### BACKGROUND OF THE INVENTION

Button panel assemblies are used in gaming machines to support a plurality of buttons to receive inputs from a user when playing a game of chance or a wager based game. Current button panel assemblies are mounted to the gaming machine door below an opening that exposes a gaming machine display that displays the game of chance.

The buttons on the button panel assemblies are electrically connected to a master gaming controller within the gaming machine by a plurality of electrical wires. A typical button has at least five wires extending outwardly there from. A player may press the buttons to cause the gaming machine to perform various functions, such as cash out, enter a wager, select pay lines, play the game of chance, and the like. Each of the plurality of buttons typically include a variety of elements, such as an actuator, a switch, and a light source positioned beneath the buttons. The actuator is coupled to the button and disposed to actuate the switch in response to a downward force applied to the button. The light source is positioned below the button to illuminate the button panel assembly, but is normally not bright enough or uniform when illuminated.

When manufacturing the button panel assembly, the buttons are individually mounted to the button panel assembly. The electrical wires are then connected to the appropriate buttons and the button panel assembly is then mounted to the gaming machine door. The electrical wires are fed though the interior of the gaming machine and connected to the master gaming controller.

Unfortunately, when the button panel assembly is mounted to the gaming machine door, there is a significant possibility that one of the many electrical wires may be pinched between the button panel assembly and the gaming machine door. Additionally, it makes it difficult for a service technician to access any of the button assemblies for maintenance and servicing as the many wires are buried among each other within the gaming machine. Moreover, the service technician is required to determine which wire is connected to which light source, button, etc. Furthermore, should any liquids be spilt on the button panel assembly, the entire button panel assembly must be replaced as the liquids damage the actuator, switch, and light source.

### BRIEF DESCRIPTION OF THE INVENTION

The invention provides for a button panel assembly connected to the gaming machine cabinet. The button panel assembly may have a waterproof layer to prevent liquids from damaging the assembly and light features to illuminate the button panel assembly.

A button panel assembly comprises a printed circuit board comprising a plurality of areas, each of the areas comprising traces for producing user input commands for a wagering game and a waterproof layer comprising a plurality of buttons, each button corresponding to at least one of the plurality of areas and configured for accepting user input for the wagering game, and at least one of the plurality of buttons being further configured to simulate a resistive force of a conventional mechanical button used for accepting user input for the wagering game.

Another embodiment of a button panel assembly comprises a printed circuit board comprising a plurality of areas, each of the plurality of areas comprising a plurality of traces for producing user input commands for a wagering game, a light source coupled to the printed circuit board, a waterproof layer comprising a plurality of buttons, each of the plurality of buttons corresponding to at least one of the plurality of areas and configured for accepting user input for the wagering game, and a cover to cover each of the plurality of buttons, wherein portions of the waterproof layer are configured for directing light from the light source to select areas of the cover.

Yet another embodiment if a button panel assembly comprises a surface cover having a bottom and a top, and a plurality of opening to receive a plurality of button covers, a bolster coupled to the bottom of the surface cover, a waterproof layer comprising a plurality of buttons, each of the plurality of buttons corresponding to at least one of the plurality of button covers and configured for accepting user input for a wagering game, a printed circuit board comprising a plurality of areas, each of the plurality of areas corresponding to each of the plurality of buttons and comprising a plurality of traces for producing user input commands for the wagering game, and a light source coupled to the printed circuit board wherein portions of the waterproof layer are configured for directing light from the light source to select areas of the plurality of button covers.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention.

In the drawings:

FIGS. 1A and 1B illustrate a top view of an embodiment of a button panel assembly.

FIG. 2 illustrates a cross sectional view of the button panel assembly.

FIG. 3 illustrates a cross-sectional view of an embodiment of a button.

FIG. 4 is a top view of an embodiment of the button illustrated in FIG. 2.

FIGS. 5A, 5B, and 5C illustrate a cross-sectional view of another embodiment of a button.

FIG. 6 is a graph showing the force applied to the button illustrated in FIG. 3.

FIG. 7 illustrates an embodiment of a gaming machine.

### DETAILED DESCRIPTION

Embodiments are described herein in the context of a button panel with printed circuit board. Those of ordinary skill in the art will realize that the following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The invention provides for a button panel assembly connected to the gaming machine cabinet. The button panel assembly may have a waterproof layer to prevent liquids from damaging the assembly and light features to direct light beams from light sources to illuminate the button panel assembly.

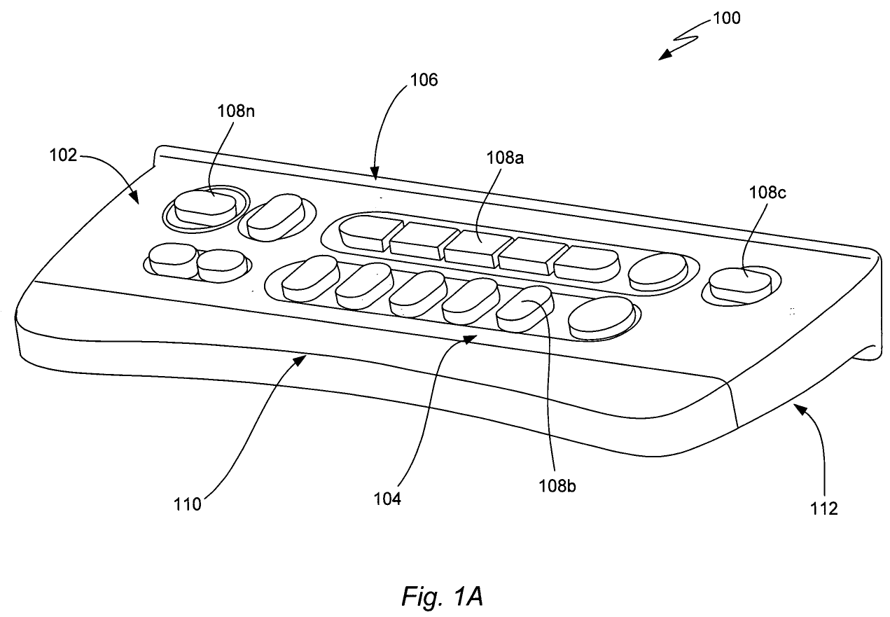

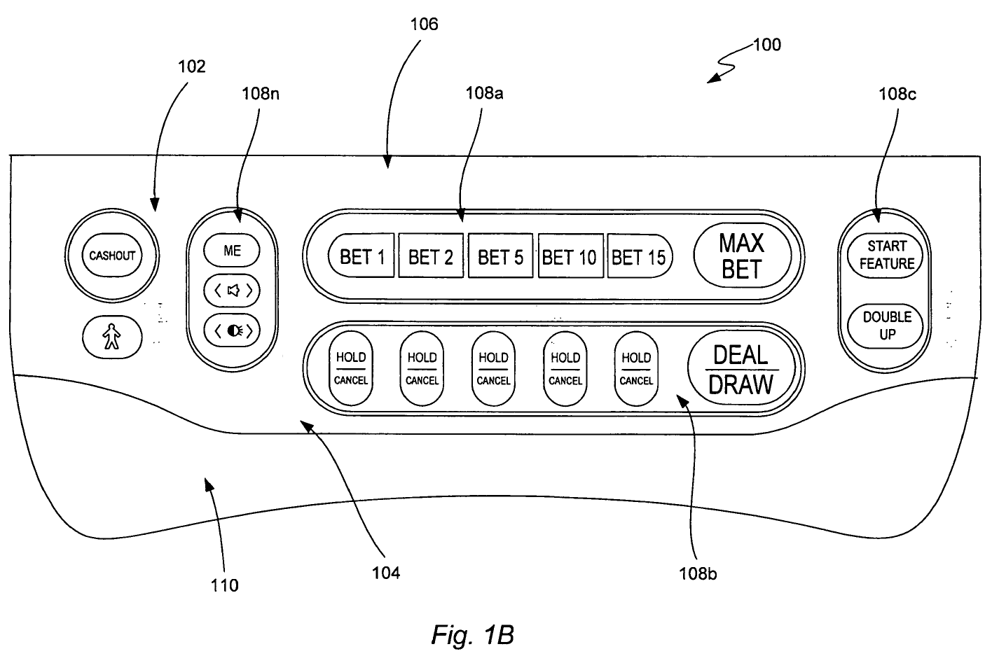

FIGS. 1A and 1B illustrate a top view of an embodiment of a button panel assembly. The button panel assembly, generally numbered 100, may have a surface cover 102 having a bottom 104 and a top 106, and a plurality of openings to receive a plurality of button covers 108a, 108b, 108c, 108n (where n is an integer). Surface cover 102 may be made from any known injection molded plastic to any desired shape. Other fabrication methods and materials may also be used such as cast aluminum or zinc. A bolster 110 may be coupled to the bottom 104 of the surface cover 102. The bolster 110 may be made from any known methods and materials such as injection molded with an elastomeric compound or compression molding. For example, the bolster 110 may be made from a 50-60 shore-A elastomeric compound such as polyurethane alloy thermoplastic elastomer or reaction injection molding self skinning polyurethane. The bolster 110 may also have a plurality of compression ribs to provide additional comfort and/or support for a player to rest upon. For example, the bolster 110 may be used as a wrist support for a player to rest his wrists on while playing the game of chance. The bolster 110 may also be designed to have a variety of features such as a cup holder, cigarette tray, or any other features.

The button panel assembly 100 may also have a bottom surface 112 made of any known metals such as a structural zinc die cast. The bottom surface 112 allows the button panel assembly 100 to have load bearing properties wherein a weighted load is transferred from the surface cover 102 to the metal bottom surface 112 without damage to the button panel assembly 100. Button panel assemblies 100 are commonly used as a step stool for technicians to reach the top of the gaming machine. Alternatively, other may use the button panel assembly 100 as a seat. Thus, the weight load may be transferred to the metal bottom surface 112 without damaging the button panel assembly 100. The button panel assembly 100 is engineered to withstand a distributed load of greater than 300 lbs without damage to the button panel assembly.

Button covers 108a, 108b, 108c, 108n may be made from any known injection molded plastic to any desired shape. Button covers 108a-n may be designed to snap into the corresponding openings and removed in a similar manner without having to remove the entire button panel assembly from the gaming machine. The button covers 108a-n may be translucent to allow for the illumination of the button panel assembly. Button covers 108a-n may also have written indicia to indicate the function of the keys. The written indicia may be written on the button cover using laser marking, in-mould decoration, and the like. The written indicia may be CASHOUT, SERVICE, VOLUME, DEAL, BET MAX, DOUBLE UP, HOLD/CANCEL, and any other features necessary to play a game of chance as illustrated in FIG. 1B.

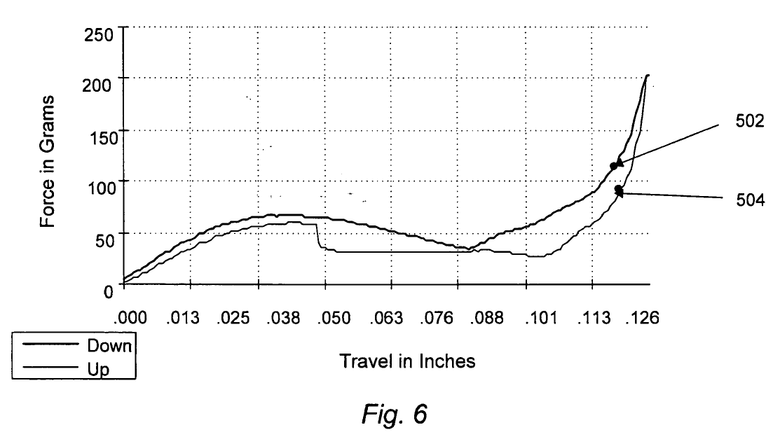

As illustrated in FIG. 1A and 1B, the button panel assembly 100 may be manufactured as a single unit connected to the cabinet of the gaming machine rather than to the gaming machine door. This allows for ease in maintenance, increased reliability, and increased life of the button panel assembly 100. Furthermore, repetitive flexing of the communication cables and wires is eliminated. Various methods for connecting the button panel assembly to the cabinet of the gaming machine is illustrated in co-pending patent application serial number [Attorney Docket IGTI P346], entitled “Rotating Quick Release Button Panel”, filed Nov. 10, 2006, which is incorporated herein by reference in its entirety for all purposes. Alternatively, the button panel assembly 100 may also be connected to the gaming machine door as illustrated and described in FIG. 6.

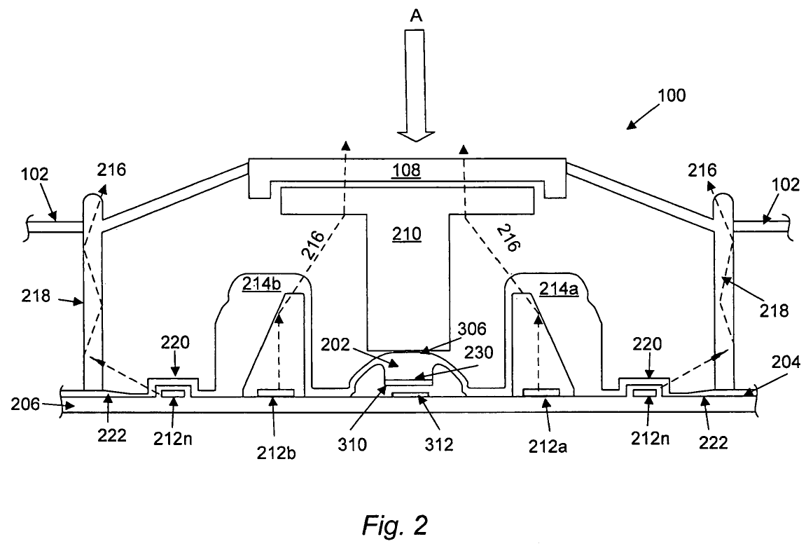

FIG. 2 illustrates a cross sectional view of the button panel assembly. The button panel assembly 100 may have a surface cover 102 and a button cover or keycap 108. The button cover 108 may be coupled to a plunger 210 to depress button 202 when a downward force A is applied to the button cover 108. Although illustrated with the use of a plunger 210, it is not necessary to use a plunger 210 as the keycap 108 itself may be designed to depress the button 202. The button 202 may be part of a continuous silicone sheet or waterproof layer 204 designed to cover, protect and prevent damage to the printed circuit board 206. The waterproof layer 204 may be made from any material, such as silicone or mylar and is able to trap and channel liquids away from the printed circuit board 206 to prevent any damage. The silicone sheet 204 may have a durometer of about 30-90 Shore A. The waterproof layer 204 prevents any liquids from beverages and/or cleaning liquids from damaging the button panel assembly 100. The waterproof layer may be designed with varying channels and at various angles to divert liquids to openings that exit at the bottom surface 112 of the button panel assembly 100.

Although illustrated as a single button 202, the waterproof layer 204 may have a plurality of buttons each configured to accept a user input for the game of chance. When the button cover 108 is pressed downward, the plunger 210 presses on the button 202. A conductive pad 310, may be placed on a bottom surface 230 of the button 202 proximate the printed circuit board 206. The conductive pad 310 contacts a plurality of traces 312 on the printed circuit board 206 which produces user input commands. The traces 312 may be made from any known materials such as silver plated or gold plated copper alloy and configured to send input signals to the master gaming controller.

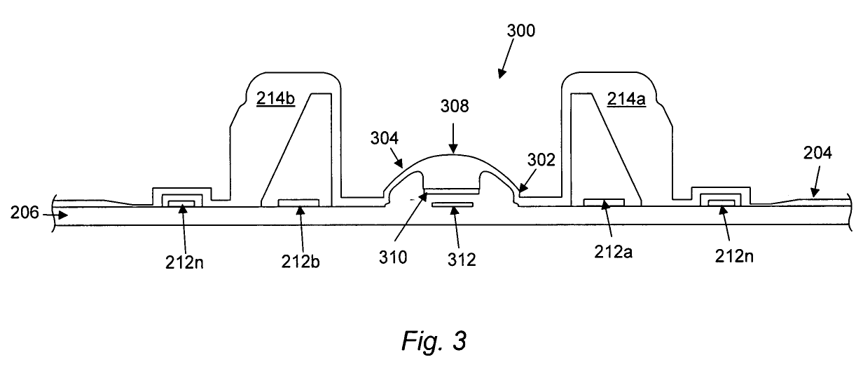

FIG. 3 illustrates a cross-sectional view of an embodiment of a button. FIG. 4 is a top view of an embodiment of the button illustrated in FIG. 2. The button, generally numbered 300, may be shaped into any shape desired to simulate a resistive force of a conventional mechanical button used for accepting user input for the wagering game. Many players are superstitious about the feel of the gaming machine buttons. Thus, the ability to simulate the resistive force of a conventional mechanical button is important. The resistive force may be simulated by forming portions of the button 300 into predetermined thicknesses and/or forming portions of the button 300 into predetermined shapes. The thickness of the button sidewall is important for proper tactile feedback as the contact force required to break over the sidewall determines the proper “feel” of the button. Additionally, simulating the audio sound of a conventional mechanical button is desirable. This may be achieved through the use of a small speaker, piezo emitter, or a mechanical bender to simulate the “click” sound of a conventional mechanical button. The sound may be emitted through an opening at the bottom surface 112 of the button panel assembly 100.

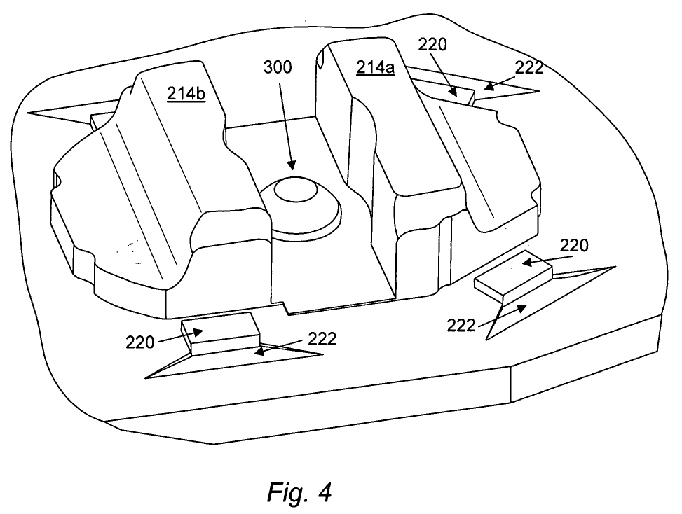

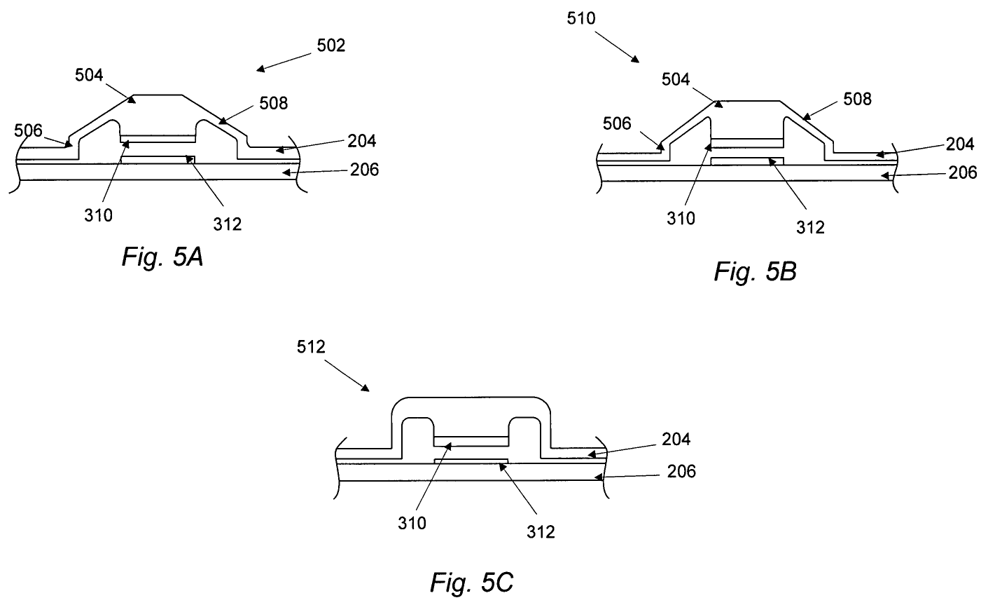

FIGS. 5A-5C illustrate a cross-sectional view of various embodiments of a button. Each button may have various thicknesses and shape. For exemplary purposes only and not intended to be limiting, the button 300 may be shaped similar to a volcano shape but having a flat top 306 as illustrated in FIG. 2 or may be a semi-circle having a convex top 308 as illustrated in FIG. 3. The resistive force may also be obtained by varying the thickness around the button 300. For exemplary purposes only and not intended to be limiting, the thickness around the base 302 of the button 300 may be thicker than the thickness at the top 304 of the button 300. Having a thicker top 304 may result in a firm button feel. Alternatively, the button 300 may have a consistent wall thickness to achieve a different feel. FIG. 5A illustrates the button 502 having a thickness greater at the top 504 and base 506 than in the sidewall 508 of the button 502. Additionally, the top 504 may be flatter than the button tops illustrated in FIG. 2 and FIG. 3. FIG. 5B illustrates another embodiment of the button 510 having a different shape and tiered thickness throughout the button. FIG. 5C illustrates yet another embodiment of the button 512 which is similar to a rectangular shaped button having multiple tiered thicknesses within the button to vary the feel of the button. Thus, the illustrated shapes and thicknesses are not intended to be limiting as any shape and thickness may be used to achieve a desired feel.

The downward resistive force applied to the button results in contact between the conductive pad 310 and the traces 312 on the printed circuit board 206. The conductive pad may be made from any conductive material such as carbon, and the like.

Each variety of shapes allows for a different feel when the button cover is depressed. FIG. 6 is a graph showing the force applied to the button illustrated in FIG. 2. The distance between the conductive pad 310 to the traces 312 on the printed circuit board 206 and may be between about 0.5 mm to 2.0 mm and have an actuation force of about 150 g to 190 g. As the button travels downward or is depressed 602, the force required to continue to depress the button increases then decreases in mid-travel due to the variation in thickness. As the button is released 604, less force is required to keep the button at that position in mid-travel. Thus, by varying the shape and thickness of the button, different amounts of force will be required to depress the button, which thereby affects the “feel” of the button.

The use of a conductive pad 310 and traces 312 on a printed circuit board 206 may replace traditional switches and wires currently used on button panel assemblies. The use of the conductive pads 310 on a printed circuit board 206 enhances serviceability of the button panel assembly. There is a decrease in the number of wires necessary to input signals to the master gaming controller. For exemplary purposes only and not intended to be limiting, there may be three wires to connect the printed circuit board to ground, three wires to connect the printed circuit board to power, and one wire to connect the printed circuit board to the master gaming controller. Thus, the amount of wires used is significantly decreased as compared to current button panel assemblies which thereby eliminates the use of many wires and enhances serviceability of the button panel assembly. The button panel assembly 100 may communicate with the master gaming controller through any known means such as a single universal serial bus, RS232, or an Ethernet cable.

Referring back to FIG. 2, a plurality of light sources 212a, 212b, 212n may be coupled to the printed circuit board 206 to illuminate the button panel assembly. Light sources 212a, 212b, 212n may be any known light source such as a light emitting diode (LED). The LED may be multi-colored to allow for the use of different colors to illuminate the button panel assembly 100. To obtain a uniform and bright color, the light sources 212a, 212b, 212n may be positioned in predetermined areas of the printed circuit board 206 where the waterproof layer 204 is designed to direct light 216 from the light source 212a, 212b, 212n to select areas of the button cover 108. For exemplary purposes only and not intended to be limiting, light source 212a may be positioned below light pipe 214a and light source 212b may be positioned below light pipe 214b. Light pipes 214a, 214b are designed to efficiently channel and focus the light 216 from light sources 212a, 212b through the plunger 210 and out through button cover 108. In another example, light source 212n may be positioned near a secondary light pipe 218 that surrounds button cover 108 to illuminate the areas around button cover 108. The light source 212n may be positioned within a predefined space 220 next to a light deflecting area 222 on the waterproof layer 204. The light deflecting area 222 The gap between the light deflecting area 222 and the secondary light pipe 218 allows for a greater area of trajectory for the light beam 216. The light 216 from the light source 212n is reflected onto the secondary light pipe 218 which may then be reflected upward to illuminate the button panel assembly 100.

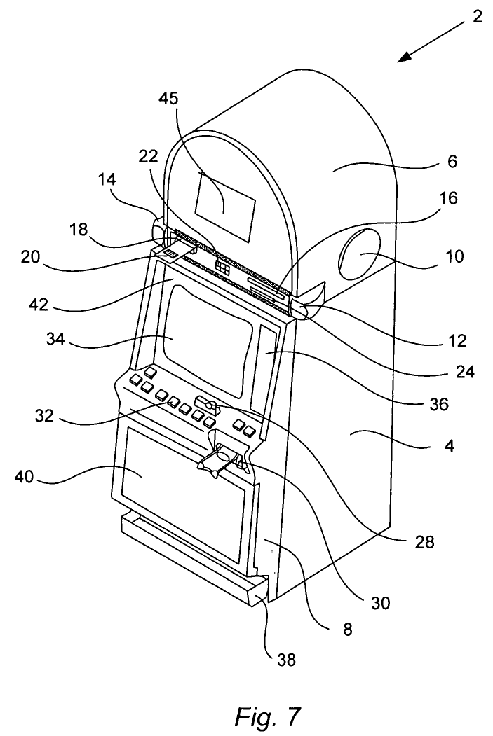

FIG. 7 illustrates an embodiment of a gaming machine. Gaming machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. Although illustrated as attached to the main door, the player-input switches or buttons 32 may also be attached to the gaming machine cabinet itself and not to the main door. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of pay lines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in FIG. 7. For example, the top box may contain a bonus wheel or a back-lit silk screened panel that may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

When a user wishes to play the gaming machine 2, he or she inserts cash through the coin acceptor 28 or bill validator 30. Additionally, the bill validator may accept a printed ticket voucher that may be accepted by the bill validator 30 as indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input device.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

While embodiments and applications have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A button panel assembly for a gaming machine, comprising:
a printed circuit board comprising a plurality of areas, each of the areas comprising traces for producing user input commands for a wagering game; and
a waterproof layer comprising a plurality of buttons, each button corresponding to at least one of the plurality of areas and configured for accepting user input for the wagering game, at least one of the plurality of buttons being further configured to simulate a resistive force of a conventional mechanical button used for accepting user input for the wagering game.

2. The button panel assembly of claim 1, further comprising:
a cover corresponding to each of the plurality of buttons; and
means for directing light to selected areas of the cover.

3. The button panel assembly of claim 1, wherein each of the plurality buttons further comprises a conductive pad on a surface of the waterproof layer proximate the printed circuit board.

4. The button panel assembly of claim 1, wherein the waterproof layer is formed of silicone.

5. The button panel assembly of claim 1, wherein the resistive force is simulated by forming portions of the plurality of buttons into predetermined thicknesses.

6. The button panel assembly of claim 1, wherein the resistive force is simulated by forming portions of the waterproof layer into predetermined shapes.

7. The button panel assembly of claim 1, wherein at least some of the plurality of buttons further comprise means for simulating a sound of a conventional mechanical button used for accepting user input for a wagering game.

8. The button panel assembly of claim 2, wherein the means for directing comprises shaped portions of the waterproof layer.

9. The button panel assembly of claim 2, wherein the means for directing comprises optical fibers.

10. The button panel assembly of claim 8, further comprising light emitting diodes disposed upon the printed circuit board, wherein the shaped portions are configured for directing light from the light emitting diodes to the selected areas.

11. A button panel assembly for a gaming machine, comprising:
a printed circuit board comprising a plurality of areas, each of the plurality of areas comprising a plurality of traces for producing user input commands for a wagering game;
a light source coupled to the printed circuit board;
a waterproof layer comprising a plurality of buttons, each of the plurality of buttons corresponding to at least one of the plurality of areas and configured for accepting user input for the wagering game; and
a cover to cover each of the plurality of buttons, wherein portions of the waterproof layer are configured for directing light from the light source to select areas of the cover.

12. The button panel assembly of claim 11, wherein at least one of the plurality of buttons is further configured to simulate a resistive force of a conventional mechanical button used for accepting user input for the wagering game.

13. The button panel assembly of claim 11, wherein each of the plurality buttons further comprises a conductive pad on a surface of the waterproof layer proximate the printed circuit board.

14. The button panel assembly of claim 12, wherein the resistive force is simulated by forming portions of the waterproof layer into predetermined thicknesses.

15. The button panel assembly of claim 12, wherein the resistive force is simulated by forming portions of the waterproof layer into predetermined shapes.

16. The button panel assembly of claim 15, wherein the predetermined shape is a semi-circle.

17. The button panel assembly of claim 11, wherein at least some of the plurality of buttons further comprise means for simulating a sound of a conventional mechanical button used for accepting user input for a wagering game.

18. The button panel assembly of claim 11, wherein the waterproof layer further comprises shaped portions configured to direct light from the light source to select areas of the cover.

19. A button panel assembly for a gaming machine, comprising:
a surface cover having a bottom and a top, and a plurality of opening to receive a plurality of button covers;
a bolster coupled to the bottom of the surface cover;
a waterproof layer comprising a plurality of buttons, each of the plurality of buttons corresponding to at least one of the plurality of button covers and configured for accepting user input for a wagering game;
a printed circuit board comprising a plurality of areas, each of the plurality of areas corresponding to each of the plurality of buttons and comprising a plurality of traces for producing user input commands for the wagering game; and
a light source coupled to the printed circuit board;
wherein portions of the waterproof layer are configured for directing light from the light source to select areas of the plurality of button covers.

20. The button panel assembly of claim 19, further comprising a metal bottom coupled to the surface cover and bolster to enclose the waterproof layer and printed circuit board.

21. The button panel assembly of claim 19, wherein at least one of the plurality of buttons is configured to simulate a resistive force of a conventional mechanical button used for accepting user input for the wagering game.

22. The button panel assembly of claim 19, wherein each of the plurality buttons further comprises a conductive pad on a surface of the waterproof layer proximate the printed circuit board.

23. The button panel assembly of claim 21, wherein the resistive force is simulated by forming portions of the waterproof layer into predetermined thicknesses.

24. The button panel assembly of claim 21, wherein the resistive force is simulated by forming portions of the waterproof layer into predetermined shapes.

25. The button panel assembly of claim 24, wherein the predetermined shape is a semi-circle.

26. The button panel assembly of claim 19, wherein at least some of the plurality of buttons further comprise means for simulating a sound of a conventional mechanical button used for accepting user input for a wagering game.

27. The button panel assembly of claim 20, wherein the button panel assembly is designed to have load bearing properties wherein a weighted load is transferred from the surface cover to the metal bottom.
